(19) United States
(12) Patent Application Publication
(10) Pub. No.: US 2003/0034080 A1
(43) Pub. Date: Feb. 20, 2003

(54) Installation collection comprising several ducts and method for fitting such a collection

(75) Inventor: Christian Second, Chene en Semine (FR)

Correspondence Address: OLIFF & BERRIDGE, PLC, P.O. BOX 19928, ALEXANDRIA, VA, 22320, US

(73) Assignee: NOVOPLASTIC, Bellegarde sur Valserine (FR)

(21) Appl. No.: 10/207,959

(22) Filed: Jul. 31, 2002

(30) Foreign Application Priority Data
Aug. 17, 2001 (FR) 01.10907

(51) Int. Cl. F16L 9/18

(52) U.S. Cl. 138/115; 138/116

(57) ABSTRACT

The present invention relates to an installation collection securely gathering together a number of installation ducts arranged parallel to one another in a longitudinally running direction, each installation duct comprising a plastic tube, rigid enough to resist any transverse stress, but flexible enough to be curved with respect to the longitudinal direction.

According to the invention, the collection comprises a flexible strip which is elongate in the longitudinal direction, and on which strip said installation ducts are arranged flat and side by side, each installation duct being connected to said strip along a generatrix line of the plastic tube, and remaining otherwise independent of the adjacent installation duct or ducts except for the transverse portion of said strip which connects it to said adjacent installation duct(s).

The present invention relates to the overall technical field of installation ducts used for transporting information in electrical or optical form or for transporting fluids or power.

### BACKGROUND OF THE INVENTION

Such installation ducts are often used to house electric cables, for example using methods of pushing, pulling or blowing. These methods are known per se. These installation ducts are, for example, buried or submerged. One of these installation ducts may for example contain a number of electric cables or fiber-optic cables. However, given the increase in the transmission of information of all kinds, it is often necessary to have several installation ducts connecting the various points of connection. One of the ideas therefore consists in having an array of installation ducts each of which can contain a number of electric cables, fiber-optic cables or other telecommunications cables.

### DESCRIPTION OF THE PRIOR ART

It is thus known practice to produce an installation collection securely gathering together a number of installation ducts arranged parallel to one another in a longitudinally running direction, each installation duct comprising a plastic tube, rigid enough to resist any transverse stress, but flexible enough to be curved with respect to the longitudinal direction.

Indeed, in document GB-1/123 331, there is produced an assembly of gas- or fluid-transfer tubes arranged flat and parallel to one another. Each of the tubes is surrounded by a sheath made of synthetic material, connected to the next sheath by fusion along a longitudinal generatrix line. It is thus possible to transfer various liquids along each of the tubes which are assembled side by side via their outer sheaths. The ducts have thus to be coated with a sufficiently thick outer sheath made of a different material so as to allow local fusion and an effective connection. Furthermore, the method of assembly described implements double extrusion and superficial fusion by welding. Such welding is produced using a heated tip, for example gas-powered, which is very tricky to set in order to obtain local fusion as the tubes pass along. This makes the method of manufacturing said installation ducts more complicated and expensive.

Document DE-G 8213407.3 also discloses a collection of tubes joined together in a mid-plane by transverse tabs. These tabs are made with the material of which said tubes are extruded. Such an assembly has the disadvantage that the tubes and the transverse connecting tabs have to be extruded simultaneously. This entails additional complexity in the extrusion machines used. Furthermore, the number of tubes that make up the assembly is determined by the actual extruder and cannot therefore be modified. Now, it is often necessary to have an assembly comprising a greater or lesser number of installation ducts, to be put to different uses.

### SUMMARY OF THE INVENTION

The object of the present invention is aimed at having an installation collection securely and flexibly gathering together a number of installation ducts and the manufacture and particularly the assembly of which does not detract from the flexibility of said collection.

Another object of the present invention is aimed at producing an installation collection the manufacture of which allows the number of installation ducts in said collection to be modified easily.

According to the invention, the installation collection comprises a flexible strip which is elongate in the longitudinal direction, and on which strip said installation ducts are arranged flat and side by side, each installation duct being connected to said strip along a generator of the plastic tube, and remaining otherwise independent of the adjacent installation duct or ducts except for the transverse portion of said strip which connects it to said adjacent installation duct.

According to the invention, the installation collection makes it possible to implement a method for fitting a number of installation ducts inside a construction of the pipe type, for example for discharging waste water, the cross section of which, which is far larger than the cross section of each installation duct, and comprising an arch.

According to one exemplary embodiment of the method according to the invention, the installation collection is sandwiched between, on the one hand, an attached interior membrane that lines the interior of the construction and is deflected radially inward at the arch and, on the other hand, said arch.

According to one embodiment of the installation collection according to the invention, the flexible strip is made of plastic and each installation duct is connected to said strip by fusing their respective plastic materials together, between the outer surface of the tube and an outer surface of said strip.

According to one embodiment of the installation collection according to the invention, each installation duct is connected to the strip by bonding using an adhesive. The latter is, for example, spread over an outer surface of the strip so as to constitute a self-adhesive surface.

One advantage of the invention lies in the fact that it is possible to keep the machines (extruders) used for manufacturing the individual ducts, a given number of ducts being assembled onto a strip at a separate workstation.

### BRIEF DESCRIPTION OF THE DRAWINGS

Other features and advantages will also become apparent from the detailed description given hereinafter with reference to the appended drawing which is given by way of example, in which:

FIG. 1 depicts an installation collection according to the invention in cross section;

FIG. 2 depicts another embodiment of an installation collection according to the invention, also in cross section;

FIG. 3 depicts an example of a construction comprising an installation collection according to the invention, in cross section.

### DESCRIPTION OF THE PREFERRED EMBODIMENTS

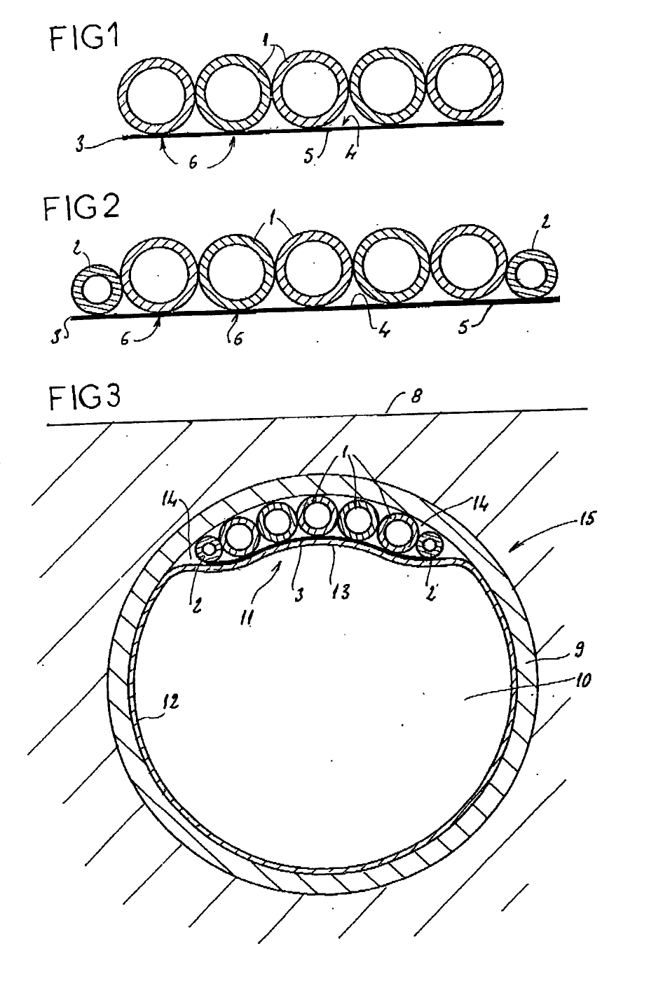

The installation collection depicted for example in FIG. 1 comprises installation ducts 1 arranged side by side or juxtaposed in one and the same plane.

The installation collection also comprises a flexible strip 3 which is elongate in the longitudinal direction of the installation ducts 1. The strip 3 has an outer surface known as the upper surface 4 and an outer surface known as the lower surface 5. Each installation duct 1 is connected to the strip 3 along a generatrix line 6 of the plastic tube of which said installation duct 1 is made and remains otherwise independent of the adjacent installation duct or ducts 1 apart from the transverse portion of said strip 3 which connects it to said adjacent installation duct(s). This joining-together of the installation ducts 1, arranged side by side, results in a juxtaposition or simple contact, with no mechanical or chemical bond.

Any twisting of the flexible strip 3 in a plane transverse to the longitudinal directions (the plane of the figure) may therefore cause the installation ducts 1 to part to a greater or lesser extent.

According to one embodiment, the flexible strip 3 is made of plastic, and each installation duct 1 is connected to said strip 3 by fusing together the respective plastic materials between the outer surface of the tube and the upper outer surface 4 of the strip 3.

According to an alternative form of embodiment of the installation collection according to the invention, each installation duct 1 is connected to the strip 3 by welding with or without the addition of a weld filler material.

According to another embodiment, each installation duct 1 is connected to the flexible strip 3 by bonding using an adhesive. This is performed for example using an adhesive of the BOSTICH-SIMSON 007® type.

According to one embodiment, the adhesive is spread over the strip 3 in such a way as to form a self-adhesive surface. The strip 3 advantageously has a thickness of between 2 and 4 mm. The thickness of the strip 3 may for example decrease toward at least one of its longitudinal edges (this is not depicted in the figures). The strip 3 thus constitutes a backing film.

The material of which this flexible strip 3 is made is, for example, linear LDPE, the installation ducts 1 being made of HDPE. It is also possible to use installation ducts 1 with an external section that decreases toward at least one of the longitudinal edges of said installation collection.

In the embodiment depicted in FIG. 2, the installation collection comprises five installation ducts 1 and two end installation ducts 2 arranged at the longitudinal edges of said collection. The end installation ducts 2 have an external section which is smaller than the sections of the other installation ducts 1.

Thus, when the flexible strip 3 is laid out flat, the transverse contour of the installation ducts 1 and end installation ducts 2 arranged side by aide has a profile in the shape of an arc of a circle. This presents a certain advantage when the installation collection is arranged or fixed against a wall which has a certain transverse curvature.

FIG. 3 depicts an installation collection according to the invention arranged operationally in a pipe 9, for example a waste water discharge pipe. This pipe 9 has a cross section 10 which is far larger than the cross section of each installation duct 1 or 2. The installation collection is arranged under the arch 11 of the pipe 9. The installation collection is, for example, suspended from the arch 11 with the flexible strip 3 facing toward the inside of the pipe 9 and the installation ducts 1, 2 facing outward and more specifically against the wall that forms the arch 11.

The installation collection is sandwiched between, on the one hand, an attached interior membrane 12 that lines the interior of the pipe 9. This membrane 12 has a deflected part 13 on which the strip 3 rests. The membrane 12 is thus deflected radially inward at the arch 11 so as to be separated from the wall of said arch 11, thus forming a housing for the installation collection.

Advantageously, the membrane 12 is made of plastic, for example linear LDPE, as is the strip 3 defined earlier, which items are integrated into one another by fusion when said membrane 12 is fitted into the pipe 9.

Gaps 14 generally remain between the installation ducts 1, 2 and between the arch 11 and the deflected part 13 of the membrane 12. These gaps 14 are advantageously filled with a stiffening and/or securing material of the concrete type. Obviously, once installed, the membrane 12 constitutes a rigid structure.

FIG. 3 represents a construction 15 for conveying fluids, of the pipe 9 type, for example a waste water discharge pipe comprising the interior lining membrane 12 and an installation collection according to the invention, which is arranged between the arch 11 and the deflected part 13, at the arch 11, of the membrane 12.

The present invention also relates to the installation of a number of installation ducts 1 inside a construction 15 of the pipe 9 type. Such a method thus implements an installation collection according to the invention.

According to this method, the installation collection is placed in the pipe 9. Next, a lining device of the remote-controled automatic robot type travels along the pipe 9 to position the installation collection against the arch 11 with the strip 3 facing toward the inside of the pipe 9. The lining membrane 12, made of a thermosetting material, is “blown” and deformed onto the interior wall of the pipe 9 using hot water. The pressing of the membrane 12 against the installation collection arranged in the arch 11 thus generates the deflected part 13.

The use of hot water makes it possible almost simultaneously to raise the membrane 12 to a temperature of about 80° C., which corresponds to the polymerization temperature of the material of which said membrane 12 is made. This membrane therefore becomes integrated into the strip 3 by fusion.

The strip 3 has the advantage of forming a thermal screen for the ducts 1, 2 of the installation collection, with respect to the heated membrane 12.

Another advantage of the installation collection according to the invention lies in the fact that the ducts 1, 2 are not integrated into the membrane 12 by fusion. Disassembly can therefore be performed easily without damaging or deforming the material of which the ducts 1, 2 are made.

The shapes, the cross sections and the dimensions of the elemental ducts 1, 2 are therefore not adversely affected during the lining operation. The ends of the ducts 1, 2 can thus easily be detached or separated from the membrane 12 and connections to other ducts 1, 2 in line or as branches can be achieved, using couplings. In spite of the integration of the installation collection into the lining membrane 12, the possibility of making subsequent connections is not adversely affected.

1. An installation collection securely gathering together a number of installation ducts arranged parallel to one another in a longitudinally running direction, each installation duct comprising a plastic tube, rigid enough to resist any transverse stress, but flexible enough to be curved with respect to the longitudinal direction, wherein said collection comprises a flexible strip which is elongate in the longitudinal direction, and on which strip said installation ducts are arranged flat and side by side, each installation duct being connected to said strip along a generatrix line of the plastic tube, and remaining otherwise independent of the adjacent installation duct or ducts except for the transverse portion of said strip which connects it to said adjacent installation duct(s).

2. The collection as claimed in claim 1, wherein the flexible strip is made of plastic and each installation duct is connected to said strip by fusing their respective plastic materials together, between the outer surface of the tube and an outer surface of said strip.

3. The collection as claimed in claim 1, wherein each installation duct is connected to said strip by welding with or without the addition of a weld filler material.

4. The collection an claimed in claim 1, wherein each installation duct is connected to said strip by bonding using an adhesive.

5. The collection as claimed in claim 4, wherein the adhesive is spread over an outer surface of the strip so as to constitute a self-adhesive surface.

6. The collection as claimed in claim 1, wherein the thickness of the strip decreases at least toward one of its longitudinal edges.

7. The collection as claimed in claim 1, wherein the external section of the ducts arranged side by side decreases toward at least one of its longitudinal edges.

8. The collection as claimed in claim 1, wherein, with the flexible strip laid out flat, the transverse contour of the ducts arranged side by side has the profile of an arc of a circle.

9. A method for fitting a number of installation ducts inside a construction of the pipe type, for example for discharging waste water, the cross section of which, which is far larger than the cross sections of each said installation duct, comprises an arch, said method implementing an installation collection as claimed in claim 1.

10. The method as claimed in claim 9, wherein the installation collection is suspended from the arch with the flexible strip facing toward the inside of the construction and the installation ducts facing outward against the wall that forms the arch of the construction.

11. The method as claimed in claim 9, wherein the installation collection is sandwiched between, on the one hand, an attached interior membrane that lines the interior of the construction and is deflected radially inward at the arch so as to be separated from the wall of the arch, and, on the other hand, said arch.

12. The method as claimed in claim 11, wherein the membrane is made of plastic, as is the flexible strip of the installation collection, which items are integrated into one another by fusion when said membrane is fitted into the construction.

13. The method as claimed in claim 11, wherein gaps between the installation ducts and between the arch and a deflected part of the membrane are filled with a material of the concrete type.

14. A construction for conveying fluid, of the waste water discharge pipe type, comprising an interior lining membrane and an installation collection as claimed in claim 1, which is arranged between the arch of said construction and a deflected part, at the arch, of said membrane.
